(19) United States
(12) Patent Application Publication
(10) Pub. No.: US 2016/0217414 A1
(43) Pub. Date: Jul. 28, 2016

(54) PROVIDING A COMMON MESSAGING FORMAT FOR COMMUNICATING DELIVERY INFORMATION WITH A VEHICLE MANUFACTURER

(71) Applicant: Justin M. Cole, Erda, UT (US)

(72) Inventor: Justin M. Cole, Erda, UT (US)

(73) Assignee: ATADVANTAGE, INC., Erda, UT (US)

(21) Appl. No.: 14/605,282

(22) Filed: Jan. 26, 2015

(51) Int. Cl. G06Q 10/08

(52) U.S. Cl. CPC G06Q 10/083

(57) ABSTRACT

A common messaging format can be used for communicating delivery information with a vehicle manufacturer. An intermediary system can be configured to provide an interface for communicating with each of a plurality of different vehicle manufacturer systems that each employ of different messaging format. The intermediary system can also provide a common interface by which the intermediary system communicates with a trucking system so that the trucking system does not need to implement each different interface employed by the different vehicle manufacturer systems. The intermediary system therefore allows a trucking system to more easily deliver vehicles for multiple vehicle manufacturers.

### CROSS-REFERENCE TO RELATED APPLICATIONS

N/A

### BACKGROUND

Vehicle manufacturers, such as Ford, Chrysler, Nissan, etc., typically employ various modes of transportation to distribute their vehicles from the manufacturing plant to the dealerships where they are sold. In most cases, the vehicles are initially transported on rail to a railroad loading ramp where they are offloaded and placed in bay locations. Once in the bay locations, a trucking service will typically pick up the vehicles for distribution to the dealerships.

Once a vehicle is placed on rail, the vehicle manufacturer will typically send a communication (oftentimes referred to as an advanced shipping notice or ASN) to a trucking service to notify the trucking service that the vehicle will be transported to the railroad loading ramp. This ASN provides a substantial amount of information about the vehicle including information that is necessary for the trucking service to deliver the vehicle (e.g., information for identifying the vehicle (e.g., VIN, make, model, color, etc.), the ramp where the vehicle will be located, the date the vehicle will arrive at the ramp, the destination (or dealership) where the vehicle is to be delivered, etc.) as well as information that the trucking service does not need to deliver the vehicle and possibly does not understand (e.g., origin codes, standard point location codes, route codes, etc.).

As the vehicle is transported via rail, additional information is generated by the railroad carrier describing the transport of the vehicle (e.g., any transfers of the vehicle between railcars). Also, once the vehicle arrives at the ramp, the ramp operator generates grounding information which identifies, among other things, that the vehicle has arrived, and the bay in which it has been placed. This grounding information can be reported to the trucking service so that the driver can retrieve the vehicle from the appropriate bay at the ramp.

Vehicle manufacturers typically use electronic data interchange (EDI) to communicate ASNs and other messages with trucking services. However, each vehicle manufacturer employs different types of messages and/or formats for such messages. For example, an ASN from one manufacturer may include different fields than an ASN from another manufacturer. Similarly, one manufacturer may require the communication of a message type that another manufacturer does not employ. Further, even if two manufacturers employ a similar message type, each manufacturer may use a different format for fields within the message. In short, the messaging systems employed by different manufacturers are not compatible. As a result, if a trucking service desires to transport vehicles for a number of manufacturers, the trucking service must have a system that can understand the messages used by the vehicle manufacturer. Due to the complexity of such formats, it can be very expensive and difficult to configure a trucking service's system to understand the ASNs of a single vehicle manufacturer let alone those of multiple vehicle manufacturers.

Furthermore, for a trucking service to receive payment for the delivery of a vehicle, most vehicle manufacturers require the trucking service to submit payment requests in accordance with its particular messaging requirements. Oftentimes, these payment requests must include much of the information that was provided in an ASN or other previously received message even if the information is not information that the trucking service needs to make the delivery. For example, some vehicle manufacturers require that the payment request include the information that was generated by the railroad carrier during the transport of the vehicle via rail. This greatly increases the difficulty of interfacing with the vehicle manufacturer's system since the trucking service typically does not understand, and would otherwise have no reason to understand, the information generated by the railroad carrier. This is also true of the information included in the ASN that is not necessary for the trucking service to deliver the vehicle.

Accordingly, for a trucking service to be eligible to deliver vehicles for a manufacturer, the trucking service must purchase or design a system that can understand the manufacturer's ASN or other messages, receive information from the railroad carrier and ramp operator, and generate payment requests based on the content of the messages and the railroad information, among other things. As a result, many trucking services are prevented from delivering vehicles for multiple vehicle manufacturers.

### BRIEF SUMMARY

The present invention extends to methods, systems, and computer program products for providing a common messaging format for communicating delivery information with a vehicle manufacturer. An intermediary system can be configured to provide an interface for communicating with each of a plurality of different vehicle manufacturer systems that each employ of different messaging format. The intermediary system can also provide a common interface by which the intermediary system communicates with a trucking system so that the trucking system does not need to implement each different interface employed by the different vehicle manufacturer systems. The intermediary system therefore allows a trucking system to more easily deliver vehicles for multiple vehicle manufacturers.

In one embodiment, the present invention is implemented as a method for providing a common messaging format for communicating delivery information between a trucking system and a plurality of different vehicle manufacturer systems. A first delivery request is received from a first vehicle manufacturer system. The first delivery request is in a first vehicle manufacturer format specific to the first vehicle manufacturer system and requests that a trucking service deliver a first vehicle to a destination. A second delivery request is generated that includes a subset of the content of the first delivery request. The second delivery request is in a common format that is used by the intermediary system to communicate delivery requests from a plurality of vehicle manufacturer systems to a trucking system employed by the trucking service. Content of the first delivery request that is not included in the subset is stored. The second delivery request is sent to the trucking system to notify the trucking service of the request to deliver the first vehicle to the destination.

In another embodiment, the present invention is implemented as an intermediary system for enabling a trucking system to communicate with a plurality of different vehicle manufacturer systems using a common interface. The intermediary system includes one or more processors and memory storing computer executable instructions which when executed by the one or more processors implement, for each of the plurality of different vehicle manufacturer systems, an interface for receiving delivery requests from the corresponding vehicle manufacture system. The execution of the computer executable instructions also implement a common interface for communicating each of the delivery requests to the trucking system such that the trucking system uses the common interface to receive delivery requests from each of the plurality of different vehicle manufacturers.

In another embodiment, the present invention is implemented as one or more computer storage media storing computer executable instructions which when executed by an intermediary system enable a trucking system to receive delivery requests from a plurality of different vehicle manufacturer systems using a common interface. A delivery request is received, from each of a plurality of different vehicle manufacturer systems and via an interface specific to the corresponding vehicle manufacturer system. The delivery request requests that a trucking service deliver a vehicle for the corresponding vehicle manufacturer. For each of the delivery requests, a corresponding delivery request is generated in accordance with a common interface used to communicate delivery requests to the trucking system. Each of the corresponding delivery requests is sent to the trucking system such that the trucking system receives delivery requests from the plurality of different vehicle manufacturers via the common interface and not via the different interfaces employed by the plurality of vehicle manufacturer systems.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing environment in which the present invention can be implemented;

FIG. 2A illustrates an example of an advanced shipping notice, which a vehicle manufacturer system sends to notify a trucking system to request that the trucking system deliver a vehicle, that is received by an intermediary system to allow the intermediary system to use a common interface to communicate the advanced shipping notice to the trucking system;

FIG. 2B illustrates an example of a message sent by a railroad system that includes routing information for a vehicle that the railroad is transporting;

FIG. 2C illustrates an example of a message sent by a ramp system that includes grounding information for a vehicle that was unloaded at the ramp;

FIG. 3 illustrates how an intermediary system stores information received from vehicle manufacturer systems, railroad systems, and ramp systems and uses a common interface to communicate with the trucking system;

FIG. 4A illustrates an example of how a common ASN format can be used to communicate ASNs to a trucking system when ASNs are received from a number of different vehicle manufacturer systems;

FIG. 4B illustrates an example of how the common ASN format can be used to communicate grounding information to the trucking system;

FIG. 5 illustrates an example of how a common status format is used to communicate status changes to the intermediary system;

FIG. 6 illustrates a flowchart of an example method for providing a common messaging format for communicating delivery information between a trucking system and a plurality of different vehicle manufacturer systems.

### DETAILED DESCRIPTION

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

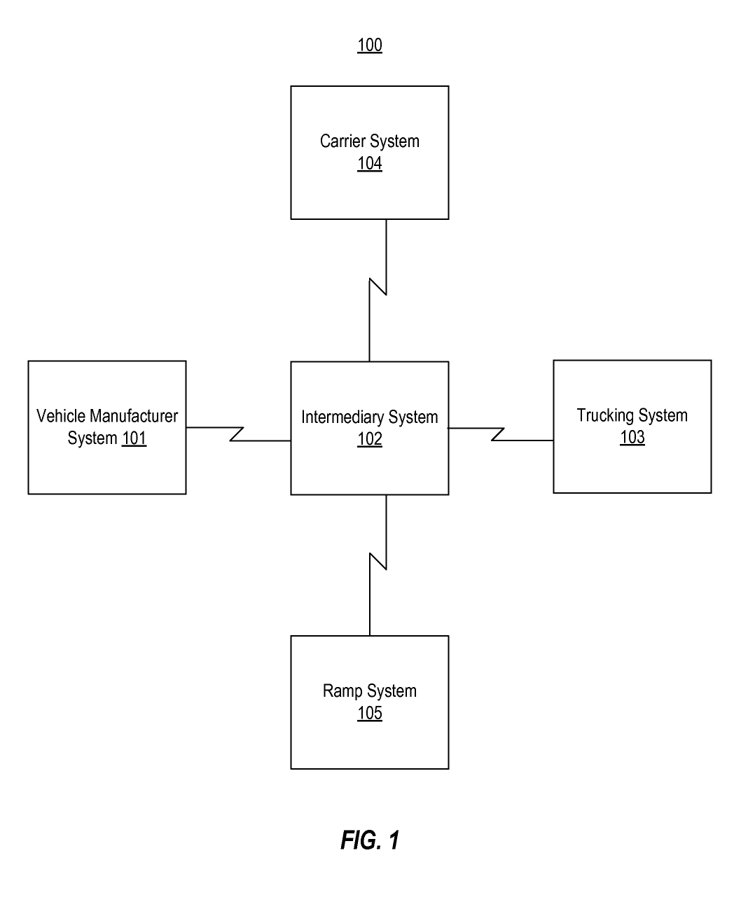

FIG. 1 illustrates an example computer environment 100 in which the present invention can be implemented. Computer environment 100 includes a vehicle manufacturer system 101, an intermediary system 102, a trucking system 103, a railroad system 104, and a ramp system 105. Each of the depicted systems is intended to generally represent any number and configuration of computing components and/or devices. For example, any of the systems can represent a single computing device (e.g., a mobile phone, tablet, or desktop computer), a server, or a cloud of interconnected computing devices. Therefore, the term “system” should be construed broadly to encompass different types of systems including those that may be formed of multiple systems or sub-systems.

Although FIG. 1 depicts that each of systems 101, 103, 104, and 105 communicate with each other via intermediary system 102, in some embodiments, systems 101, 103, 104, and 105 can communicate directly with each other. Accordingly, the present invention should not be limited to any particular computer environment, but should encompass the functionality described below regardless of the particular computer environment in which the functionality is implemented.

Vehicle manufacturer system 101 can represent the computing system employed by a vehicle manufacturer to communicate messages regarding the distribution of vehicles. For example, system 101 can represent the system employed by Ford Motor Company to coordinate the distribution of its vehicles via rail, truck, and other modes of transportation. A specific example of a vehicle manufacturer system 101 is Ford's centralized outbound payment authorization and control (COPAC) system. Of course, the present invention should not be limited to use with this single Ford system, but extends to use with any system of any vehicle manufacturer.

Trucking system 103 can represent the computing system employed by a trucking service to coordinate its vehicle delivering activities. As will be further described below, by employing the present invention, trucking system 103 can be implemented much more easily and simply.

Railroad system 104 can represent the computing system employed by a railroad carrier to report information about vehicles that the railroad carrier is transporting. Ramp system 105 can represent the computing system employed by the operator of a railroad loading ramp to report information about vehicles that are unloaded and stored at the loading ramp. In some cases, the railroad carrier and the ramp operator can be the same entity, and therefore railway system 104 and ramp system 105 could be viewed as a single system.

Although not shown, computer environment 100 can, and typically would, include multiples of systems 101, 103, 104, and 105. For example, multiple vehicle manufacturers (e.g., Ford, Chrysler, Nissan, etc.) may each maintain a vehicle manufacturer system 101. Similarly, multiple railroad carriers and operators may each maintain a railroad system 104 or ramp system 105 respectively. Further, many different trucking services may maintain a trucking system 103. However, for simplicity and clarity, the present invention will be described using a single instance of each system.

As is described in the Background, prior to the present invention, if a trucking service desired to distribute vehicles for a manufacturer, the trucking service would have to configure trucking system 103 to communicate directly with vehicle manufacturer system 101 in accordance with the messaging format employed by the manufacturer. Trucking system 103 may also have to be configured to receive messages from railroad system 104 and ramp system 105. In other words, in prior art configurations, there would be no intermediary system 102 to provide the functionality described below.

In accordance with embodiments of the present invention, intermediary system 102 can act as an intermediary between vehicle manufacturer system 101 and trucking system 103 to simplify the interface that trucking system 103 must implement to communicate with vehicle manufacturer system 101. Intermediary system 102 can be configured to directly interface with each of a number of vehicle manufacturer systems 101 (e.g., a system for Ford, a system for Chrysler, a system for Nissan, etc.) while providing a common and simplified interface by which a trucking system 103 can receive messages from and transmit messages to any of the number of vehicle manufacturer systems 101. In other words, intermediary system 102 allows a trucking system 103 to distribute vehicles for one or more manufacturers without having to understand the messaging format/requirements used by each manufacturer.

Intermediary system 102 may also act as a storage point for information contained in messages transmitted by vehicle manufacturer system 101 to a trucking system 103 as well as for information received from railroad system 104 and ramp system 105. As stated above, many vehicle manufacturer systems 101 require that a trucking system 103 include information in its messages sent to the vehicle manufacturer system that would otherwise be irrelevant to the trucking system. Intermediary system 102 can store such information, rather than including it in communications sent to trucking system 103, and later retrieve such information for inclusion in messages sent back to vehicle manufacturer system 101.

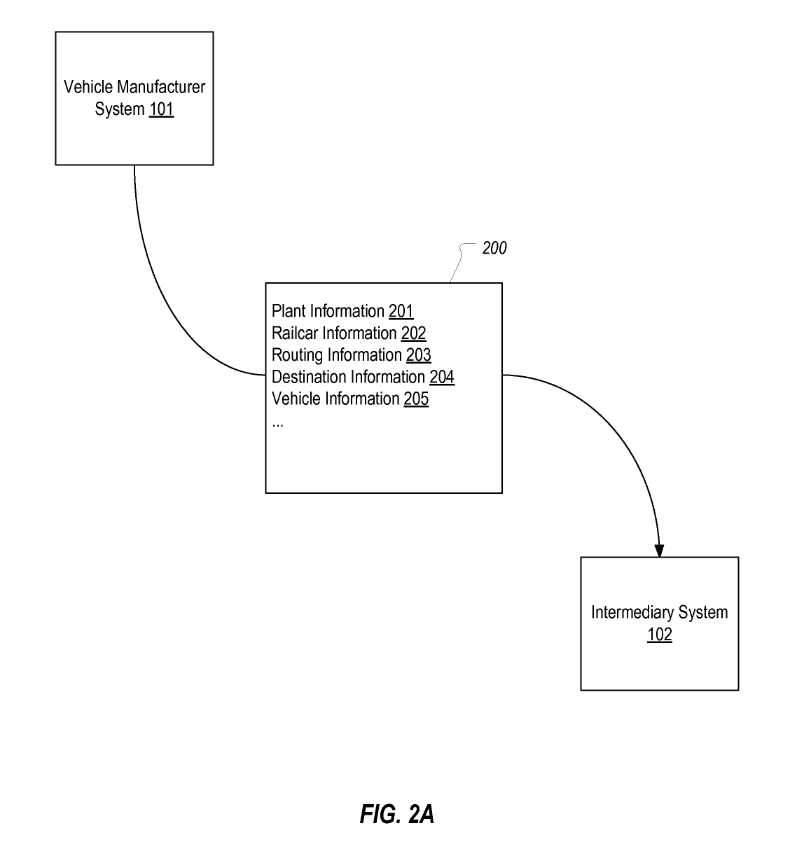

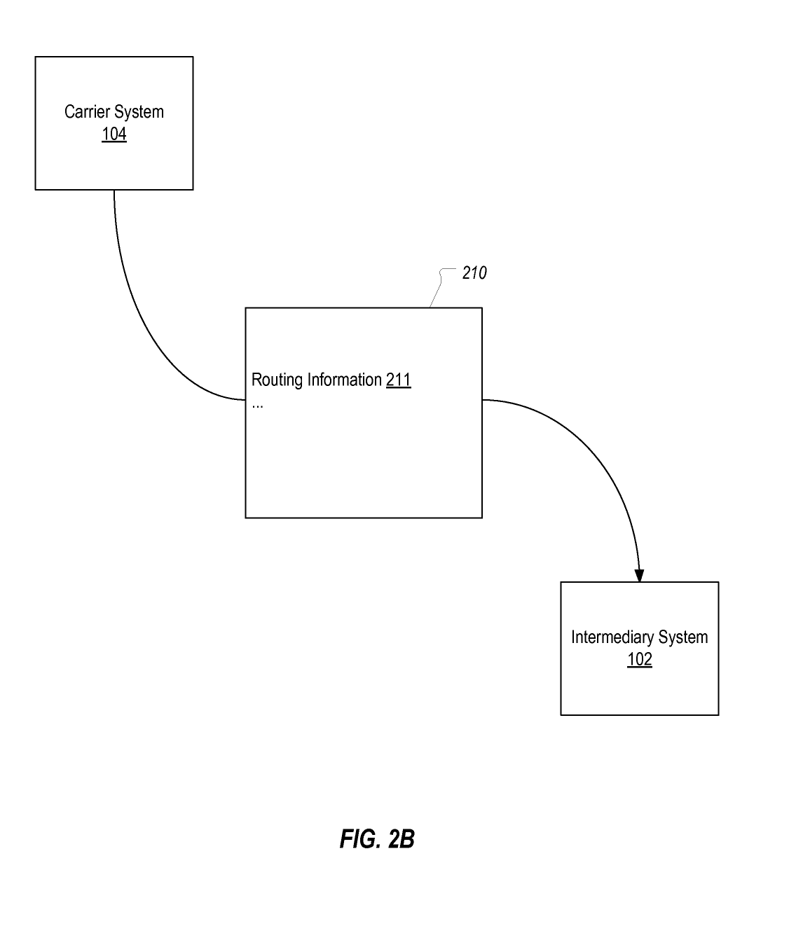

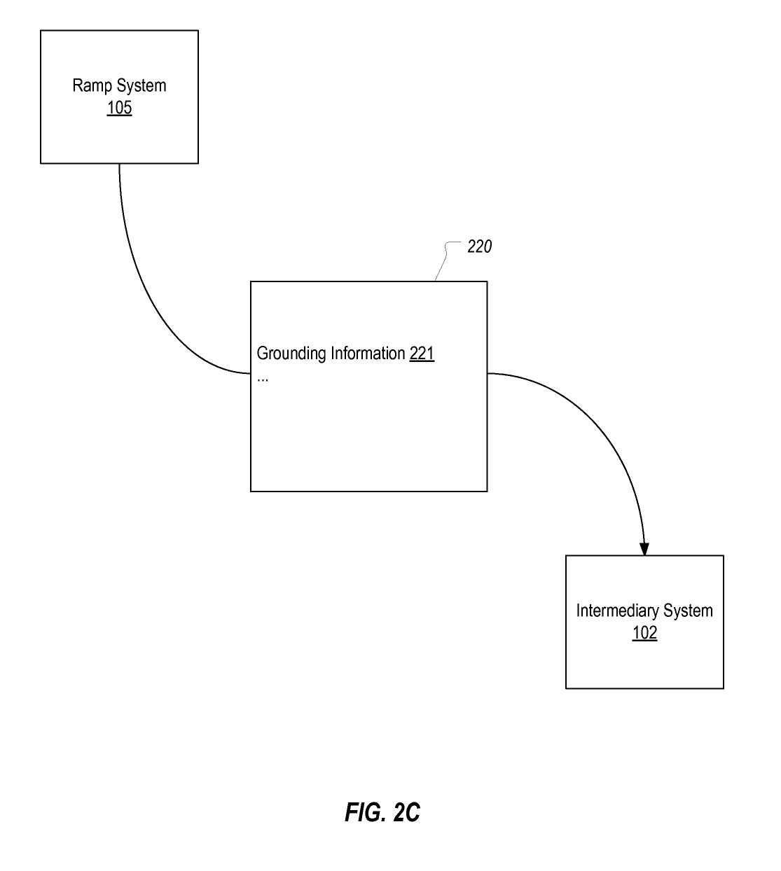

FIGS. 2A-2C illustrate the functionality performed by intermediary system 102 in response to vehicle manufacturer system 101 sending a message or messages (e.g., an ASN) to trucking system 103 to notify the trucking service of the pending arrival of a vehicle at a railroad loading ramp. As described above, this type of message can typically contain many different types of information. For example, as shown in FIG. 2A, message 200 includes many different types of information including plant information 201, railcar information 202, routing information 203, destination information 204, and vehicle information 205. These five general types of information are intended to be exemplary only and other types of information can also be included in message 200. Also, message 200 can represent one or more messages that may be transmitted at different times during the vehicle transport process.

Plant information 201 can include information about the plant where the vehicle was manufactured such as an identifier of the plant, an identifier of a ramp at the plant where the vehicle was loaded, etc. Railcar information 202 can include information about the railcar or railcars that are used to ship the vehicle such as an identifier of the railcar, an identifier of the type of railcar (e.g., an enclosed railcar, shielded railcar, etc.), a number of vehicles on the railcar, a position of a vehicle on the railcar (e.g., the position of a vehicle containing keys and/or invoices for the vehicle), etc. Routing information 203 can include information about the route that the vehicle will travel including an identifier of destination ramp (e.g., where the vehicle will be picked up by the trucking service), a ship through ramp (e.g., a destination that the vehicle should be shipped through), etc. Destination information 204 can include information about the ultimate destination of the vehicle (i.e., where the trucking service will deliver the vehicle) such as a name of a dealer, a location of a dealer, etc. Vehicle information 205 can include information describing the vehicle such as a VIN, a color of the vehicle, a wheelbase of the vehicle, body options of the vehicle, etc.

As stated above, a trucking service does not need much of this information to be able to deliver a vehicle. For example, a trucking service may only need to know a destination ramp where the vehicle will be unloaded, an identifier of the vehicle, and a destination where the vehicle should be delivered. Accordingly, intermediary system 102 can receive message 200 rather than allowing message 200 to be sent directly to trucking system 103 so that trucking system 103 will not be required to understand the format/contents of message 200.

As described above, during the transport of the vehicle via rail, railroad system 104 may also generate information describing the transport of the vehicle such as information describing the transfer of the vehicle between railcars among possibly other things. FIG. 2B illustrates that railroad system 104 transmits message 210 which includes routing information 211 defining such transfers or other routing information. Routing information 211 typically is not pertinent to the trucking service's task of delivering the vehicle. However, many vehicle manufacturers require trucking system 103 to provide at least some of this routing information to vehicle manufacturer system 101 when making a request for payment. As shown in FIG. 2B, intermediary system 102 can be configured to receive message 210 so that it is not transmitted directly to trucking system 103 thereby relieving trucking system 103 from needing to understand the format/contents of message 210 which may vary between different railroad systems.

Further, once a vehicle arrives at a destination ramp, ramp system 105 may generate grounding information describing the location of the vehicle at the ramp (e.g., a bay in which the vehicle is placed). FIG. 2C illustrates that ramp system 105 sends a message 220 that contains grounding information 221. Again, intermediary system 102 can be configured to receive message 220 rather than allowing it to be transmitted directly to trucking system 103 thereby relieving trucking system 103 from needing to understand the format/contents of message 220 which may vary between different ramp systems.

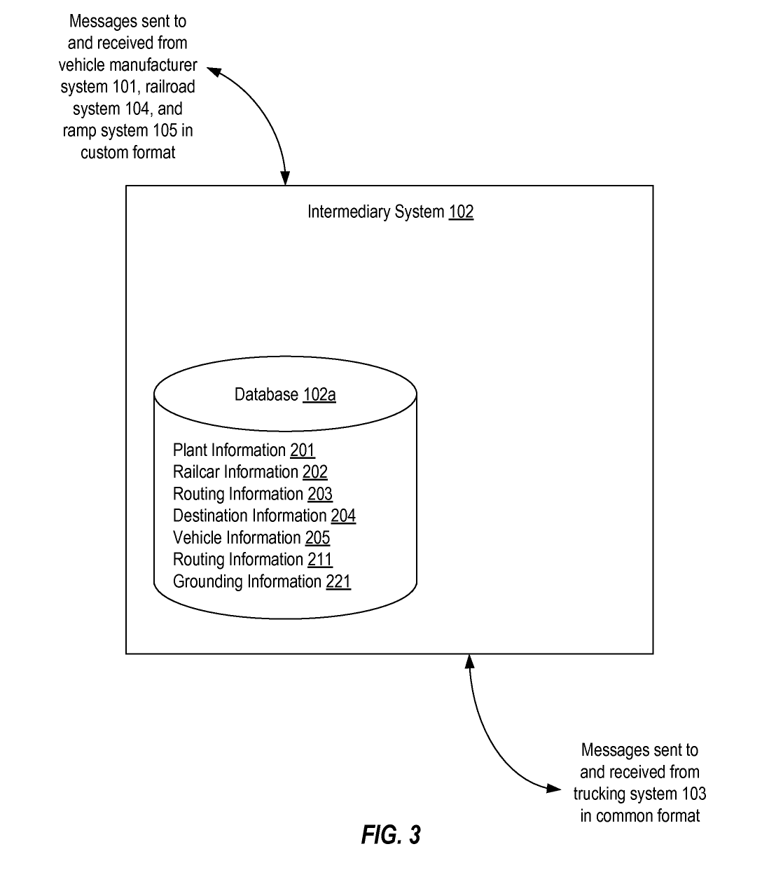

FIG. 3 illustrates that intermediary system 102 includes a database 102a for storing the information that is received from vehicle manufacturer system 101, railroad system 104, and ramp system 105. By storing this information, intermediary system 102 can use a common messaging format to transmit relevant information to trucking system 103 to enable the trucking service to pick up and deliver a vehicle and to receive notifications back from trucking system 103 once a vehicle is delivered. Intermediary system 102 can also use the stored information to create appropriate messages to transmit back to vehicle manufacturer system 101 including to request payment. By employing a common messaging format between intermediary system 102 and trucking system 103, intermediary system 102 abstracts the complex and detailed messaging formats employed by the various vehicle manufacturer systems, railroad systems, and ramp systems.

Intermediary system 102 can employ various common message formats (i.e., a common interface) to communicate with trucking system 103. A first message format can be used to communicate an advanced shipping notice to trucking system 103 when the trucking service has been assigned a vehicle to deliver. In this specification, messages in this first message format will be referred to as common ASN format messages. A common ASN format message can include fields for a subset of the information received by intermediary system 102 about a vehicle. This subset can include the information that the trucking service needs to pick up and deliver the vehicle while excluding information that is not necessary to perform these tasks. In a particular example, the common ASN format can include fields for vehicle information (e.g., manufacturer, VIN, make, model, color, weight, wheel base, etc.), a pick up location (e.g., an identifier/address of the ramp where the vehicle will be unloaded from rail, a bay location at the ramp, a date/time when the vehicle will be in the bay, etc.), and a delivery location (e.g., a dealership/destination name and address). The trucking service can therefore use this subset to identify the vehicle and its characteristics, where to pick it up, and where to deliver it.

Intermediary system 102 may send a first common ASN format message upon receiving an ASN from vehicle manufacturer system 101 that includes all of the information known at that point. Then, as intermediary system 102 receives additional information (e.g., a bay location, date, and time from ramp system 105), it can send one or more additional common ASN format messages that contain the additional information. In some embodiments, the common ASN format can include a field which defines the reason why the message is being sent. For example, the field may specify that the message is sent in response to an ASN, in response to receiving grounding information (e.g., the bay location, date, and time), in response to a change in information previously sent (e.g., a new destination), etc.

This common ASN format can be used to transmit this information regardless of the vehicle manufacturer that is requesting that the vehicle be delivered. In other words, the same common ASN format can be used to notify a trucking service of a vehicle to be delivered when the manufacturer requesting delivery is Ford, Honda, Toyota, Nissan, etc. in spite of the different formats these manufacturers use for their ASNs.

A second message format can be used by intermediary system 102 to receive status information back from trucking system 103 regarding the delivery of a vehicle. In this specification, messages in the second message format will be referred to as common status format messages. A common status format message can include fields for an identifier of the vehicle (e.g., the VIN), an identification of the status change (e.g., vehicle picked up from ramp, vehicle delivered, delivery on hold, delivery cancelled, estimated delivery date, etc.), and a date/time for the status change. In some embodiments, a common status format message may also include fields for information about the delivery such as an amount of fuel used for the delivery. This common status format can therefore be used by trucking system 103 to report changes in the status of a delivery regardless of which manufacturer's vehicle is being delivered.

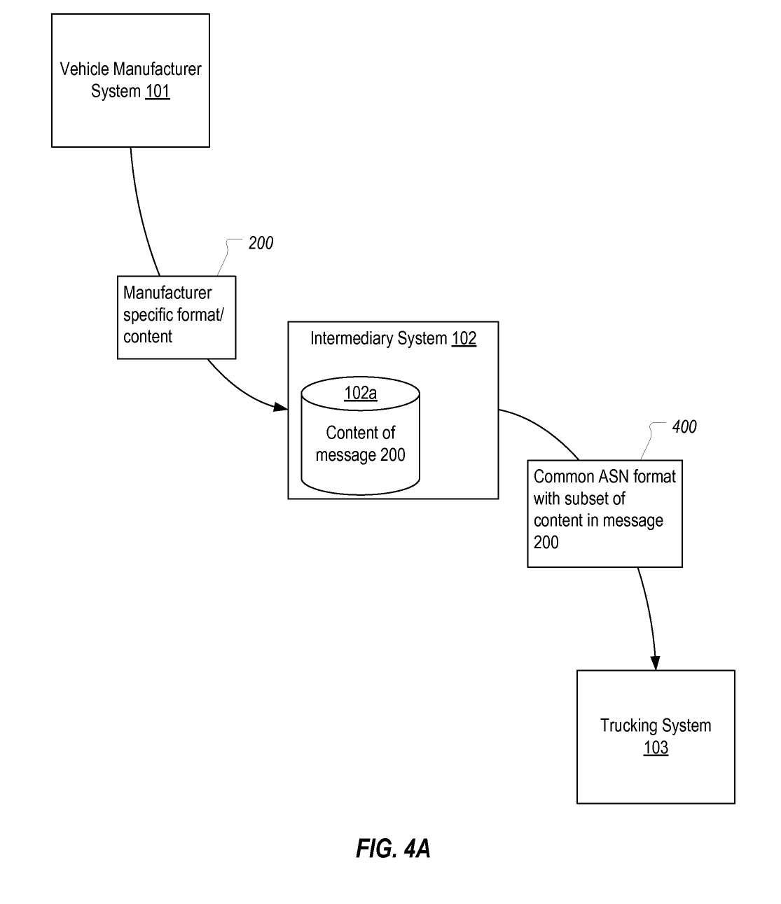

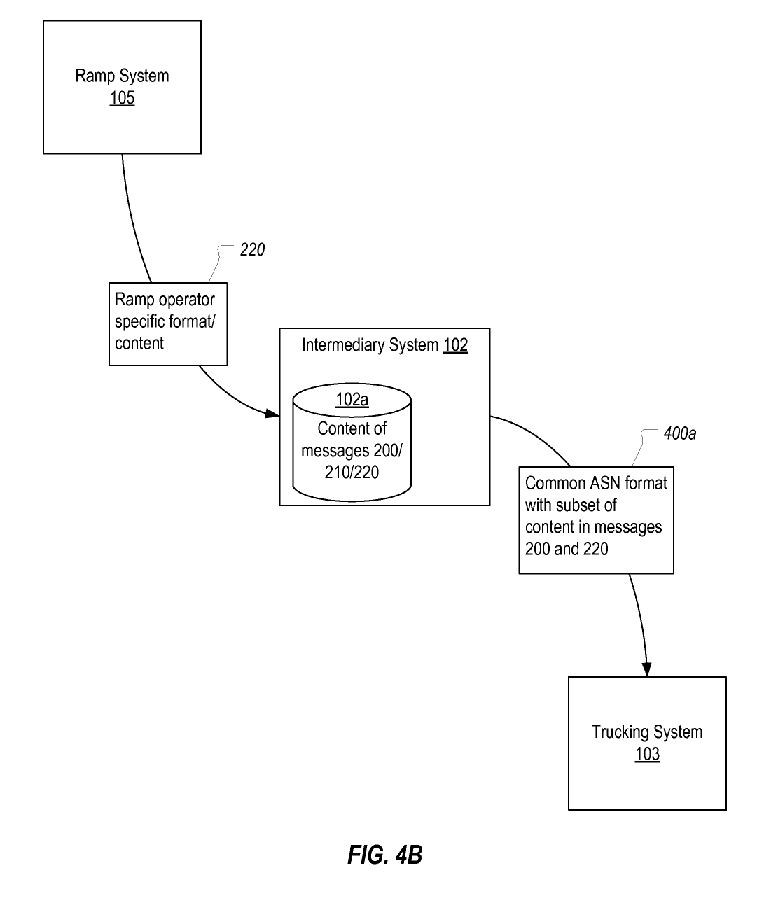

FIG. 4A provides an example of how intermediary system 102 can generate a common ASN format message upon receiving an ASN message 200 from vehicle manufacturer system 101 for a particular vehicle. As shown, intermediary system 102 can store the contents of message 200 and generate a common ASN format message 400 that includes a subset of the content of message 200. Intermediary system 102 then sends message 400 to trucking system 103.

FIG. 4B provides an example of how intermediary system 102 can send an additional common ASN format message upon receiving grounding information from ramp system 105 for the particular vehicle. As shown, intermediary system 102 sends common ASN format message 400a which includes the contents of message 400 and additional grounding information that the trucking service can use to identify where the particular vehicle will be and when it will be there. Although not shown, FIG. 4B assumes that intermediary system 102 has also received message 210 from railroad system 104 and has stored information from this message.

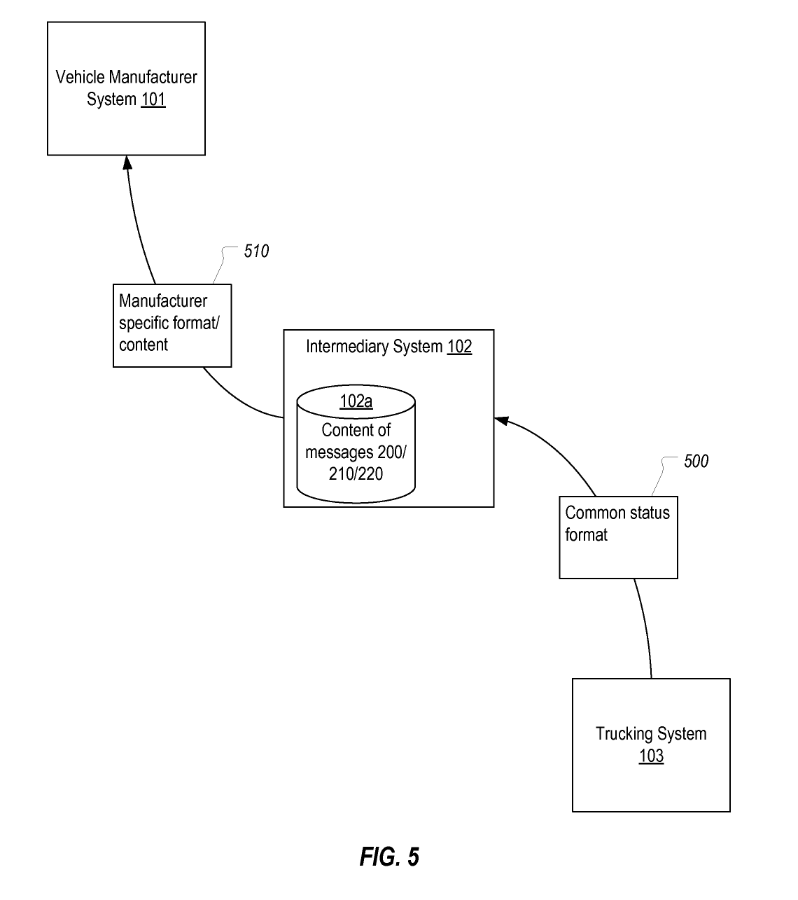

FIG. 5 provides an example of how trucking system 103 can use the common status format to transmit status messages back to intermediary system 102 to enable intermediary system 102 to communicate delivery information back to vehicle manufacturer system 101. As shown, trucking system 103 sends common status format message 500 to intermediary system 102 to inform intermediary system 102 of a status change for a vehicle delivery. In this example, it will be assumed that the status change is the successful delivery of the vehicle. In response to message 500, intermediary system 102 can use the information stored in database 102a (and possibly information provided in message 500) to create a payment request message 510 to be sent to vehicle manufacturer system 101. The format and content of payment request message 510 is specific to the vehicle manufacturer. Also, with many vehicle manufacturers, the content includes content received from railroad system 104 and ramp system 105. Intermediary system 102 abstracts the format and content of such messages from trucking system 103 so that trucking system 103 only needs to understand the common status format to request payment for a delivery.

Intermediary system 102 may employ similar common formats for communicating other types of messages such as to allow trucking system 103 to report damage to a vehicle (in which case, intermediary system 102 can create a manufacturer specific message to report the damage using information provided by trucking system as well as information stored in database 102a), to report errors to trucking system 103 (e.g., when delivery data reported by trucking system 103 in message 500 is not valid), to report a notice of payment to trucking system 103, or to allow trucking system 103 to report information on a vehicle that is being or was delivered by the trucking service in response to a request that was not made through an ASN (e.g., when the vehicle manufacturer made a telephone call to request that the trucking service deliver a vehicle). By employing a common format for such messages, trucking system 103 is further relieved from needing to understand the specific format/content requirements for reporting damage to the vehicle manufacturer, receiving error notifications from the vehicle manufacturer, or requesting payment for the delivery of a vehicle that was requested outside the normal means. For example, a common damage format can include fields for reporting damage using common descriptions.

In some embodiments, intermediary system 102 can be configured to automatically correct errors in information provided by trucking system 103, railroad system 104, or ramp system 105. For example, if any of these systems provided an incorrect date, intermediary system 102 may be able to detect the error and provide a proper date. In this way, intermediary system 102 can minimize the occurrence of errors in requests for payment or other requests sent to vehicle manufacturer system 101.

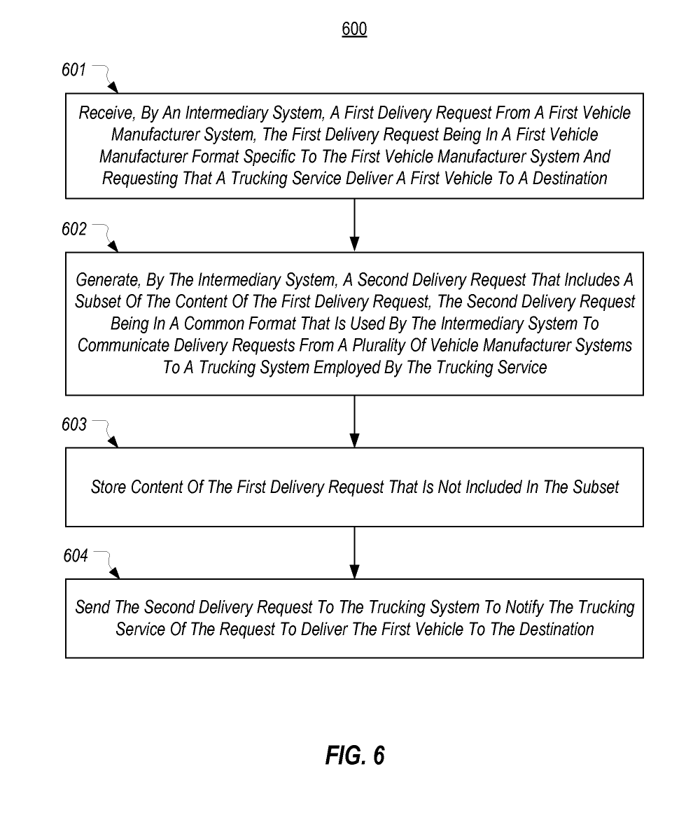

FIG. 6 illustrates a flowchart of an example method 600 for providing a common messaging format (or common interface) for communicating delivery information between a trucking system and a plurality of different vehicle manufacturer systems. Method 600 will be described with reference to FIGS. 1-5.

Method 600 includes an act 601 of receiving, by an intermediary system, a first delivery request from a first vehicle manufacturer system. The first delivery request is in a first vehicle manufacturer format specific to the first vehicle manufacturer system and requests that a trucking service deliver a first vehicle to a destination. For example, the first delivery request can be an advanced shipping notice (e.g., ASN 200) received from Ford, Nissin, Honda, or another vehicle manufacturer that is formatted in accordance with the specific format/interface employed by the vehicle manufacturer's system.

Method 600 includes an act 602 of generating, by the intermediary system, a second delivery request that includes a subset of the content of the first delivery request. The second delivery request is in a common format that is used by the intermediary system to communicate delivery requests from a plurality of vehicle manufacturer systems to a trucking system employed by the trucking service. For example, intermediary system 102 can generate common ASN format message 400 so that a common format is employed regardless of which vehicle manufacturer system is requesting delivery of a vehicle.

Method 600 includes an act 603 of storing content of the first delivery request that is not included in the subset. For example, intermediary system 102 can store content of ASN message 200 that the trucking service does not need to know to deliver the vehicle.

Method 600 includes an act 604 of sending the second delivery request to the trucking system to notify the trucking service of the request to deliver the first vehicle to the destination. For example, intermediary system 102 can send common ASN format message 400 to trucking system 103.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. A method, implemented by an intermediary system, for providing a common messaging format for communicating delivery information between a trucking system and a plurality of different vehicle manufacturer systems, the method comprising:
receiving, by an intermediary system, a first delivery request from a first vehicle manufacturer system, the first delivery request being in a first vehicle manufacturer format specific to the first vehicle manufacturer system and requesting that a trucking service deliver a first vehicle to a destination;
generating, by the intermediary system, a second delivery request that includes a subset of the content of the first delivery request, the second delivery request being in a common format that is used by the intermediary system to communicate delivery requests from a plurality of vehicle manufacturer systems to a trucking system employed by the trucking service;
storing content of the first delivery request that is not included in the subset; and
sending the second delivery request to the trucking system to notify the trucking service of the request to deliver the first vehicle to the destination.

2. The method of claim 1, further comprising:
receiving, by the intermediary system, grounding information from a ramp system, the grounding information identifying a location of the first vehicle after the first vehicle is unloaded from a railcar; and
sending a third delivery request to the trucking system that includes at least a portion of the grounding information, the third delivery request being in the common format.

3. The method of claim 2, wherein the third delivery request includes the content of the second delivery request.

4. The method of claim 1, further comprising:
receiving, by the intermediary system, routing information from a railroad system that identifies one or more railcars on which the first vehicle was transported by rail; and
storing the routing information.

5. The method of claim 1, further comprising:
receiving, from the trucking system, a status message that identifies that the first vehicle has been delivered to the destination, the status message being in a common format used by the intermediary system to receive status changes regarding delivery of vehicles of a plurality of different vehicle manufacturers;
generating a payment request in accordance with the first vehicle manufacturer format, the payment request including content of the first delivery request that was not included in the subset and information contained in the status message received from the trucking system; and
sending the payment request to the first vehicle manufacturer system to request payment to the trucking service for delivery of the first vehicle to the destination.

6. The method of claim 2, further comprising:
receiving, from the trucking system, a status message that identifies that the first vehicle has been delivered to the destination, the status message being in a common format used by the intermediary system to receive status changes regarding delivery of vehicles of a plurality of different vehicle manufacturers;
generating a payment request in accordance with the first vehicle manufacturer format, the payment request including content of the first delivery request that was not included in the subset, information contained in the status message received from the trucking system, and at least a portion of the grounding information received from the ramp system; and
sending the payment request to the first vehicle manufacturer system to request payment to the trucking service for delivery of the first vehicle to the destination.

7. The method of claim 4, further comprising:
receiving, from the trucking system, a status message that identifies that the first vehicle has been delivered to the destination, the status message being in a common format used by the intermediary system to receive status changes regarding delivery of vehicles of a plurality of different vehicle manufacturers;
generating a payment request in accordance with the first vehicle manufacturer format, the payment request including content of the first delivery request that was not included in the subset, information contained in the status message received from the trucking system, and at least a portion of the routing information received from the railroad system; and
sending the payment request to the first vehicle manufacturer system to request payment to the trucking service for delivery of the first vehicle to the destination.

8. The method of claim 1, further comprising:
receiving, by the intermediary system, a fourth delivery request from a second vehicle manufacturer system, the fourth delivery request being in a second vehicle manufacturer format specific to the second vehicle manufacturer system and requesting that the trucking service deliver a second vehicle to a second destination;
generating, by the intermediary system, a fifth delivery request that includes a subset of the content of the fourth delivery request, the fifth delivery request being in the common format;
storing content of the fourth delivery request that is not included in the subset; and
sending the fifth delivery request to the trucking system to notify the trucking service of the request to deliver the second vehicle to the second destination.

9. The method of claim 8, further comprising:
receiving, from the trucking system, a second status message that identifies that the second vehicle has been delivered to the second destination, the second status message being in the common format used by the intermediary system to receive status changes;
generating a second payment request in accordance with the second vehicle manufacturer format, the second payment request including content of the fourth delivery request that was not included in the subset and information contained in the second status message received from the trucking system; and
sending the second payment request to the second vehicle manufacturer system to request payment to the trucking service for delivery of the second vehicle to the second destination.

10. The method of claim 1, further comprising:
receiving, from the trucking system, a first damage notification that identifies damage that occurred to the first vehicle, the first damage notification being in a common format used by the intermediary system to receive damage notifications regarding vehicles of a plurality of different vehicle manufacturers; and
generating a second damage notification in accordance with the first vehicle manufacturer format; and
sending the second damage notification to the first vehicle manufacturer system to notify the first vehicle manufacturer of the damage that occurred to the first vehicle.

11. The method of claim 5, further comprising:
receiving, from the first vehicle manufacturer system, a first payment notification identifying a payment to the trucking service for the delivery of the first vehicle, the payment notification being in the first vehicle manufacturer format;
generating a second payment notification in a common format used by the intermediary system to communicate payment notifications from a plurality of vehicle manufacturer systems to the trucking system; and
sending the second payment notification to the trucking system.

12. The method of claim 1, further comprising:
receiving, from the trucking system, a delivery notification that identifies that the trucking system delivered a second vehicle of the first vehicle manufacturer to a second destination, the delivery notification being in a common format used by the intermediary system to receive delivery notifications from the trucking service for the delivery of vehicles of a plurality of vehicle manufacturers when the intermediary system has not previously received a delivery notification from a vehicle manufacturer for a particular vehicle; and
generating a payment request in accordance with the first vehicle manufacturer format, the payment request including content of the delivery notification received from the trucking system.

13. The method of claim 5, wherein the content that was not included in the subset includes one or more of origin codes, standard point location codes, or route codes.

14. An intermediary system for enabling a trucking system to communicate with a plurality of different vehicle manufacturer systems using a common interface, the system comprising:
one or more processors; and
memory storing computer executable instructions which when executed by the one or more processors perform a method comprising:
implementing, for each of the plurality of different vehicle manufacturer systems, an interface for receiving delivery requests from the corresponding vehicle manufacture system; and
implementing a common interface for communicating each of the delivery requests to the trucking system such that the trucking system uses the common interface to receive delivery requests from each of the plurality of different vehicle manufacturers.

15. The intermediary system of claim 14, wherein the common interface is also configured to receive status changes from the trucking system regarding the delivery of vehicles of any of the plurality of vehicle manufacturers.

16. The intermediary system of claim 14, wherein the common interface is also configured to receive damage notifications from the trucking system regarding damage to vehicles of any of the plurality of vehicle manufacturers.

17. The intermediary system of claim 14, wherein the common interface is also configured to communicate payment notifications from each of the plurality of vehicle manufacturer systems to the trucking system.

18. The intermediary system of claim 14, wherein the method further comprises:
implementing, for each of one or more railroad systems or ramp systems, an interface for receiving communications from the corresponding railroad system of ramp system; and
wherein the interface for each of the vehicle manufacturer systems is configured to communicate payment requests to the corresponding vehicle manufacturer system such that a payment request for the delivery of a particular vehicle includes information from a delivery request for the particular vehicle and from one or more communications received from a railroad system or ramp system regarding the transport of the particular vehicle.

19. The intermediary system of claim 14, further comprising:
a database for storing content of the delivery requests including content that is not included in delivery requests sent via the common interface to the trucking system but that is included in payment requests sent to the vehicle manufacturer systems.

20. One or more computer storage media storing computer executable instructions which when executed by an intermediary system enable a trucking system to receive delivery requests from a plurality of different vehicle manufacturer systems using a common interface, the method comprising:
receiving, from each of a plurality of different vehicle manufacturer systems and via an interface specific to the corresponding vehicle manufacturer system, a delivery request that requests that a trucking service deliver a vehicle for the corresponding vehicle manufacturer;
for each of the delivery requests, generating a corresponding delivery request in accordance with a common interface used to communicate delivery requests to the trucking system; and
sending each of the corresponding delivery requests to the trucking system such that the trucking system receives delivery requests from the plurality of different vehicle manufacturers via the common interface and not via the different interfaces employed by the plurality of vehicle manufacturer systems.
